(19) United States
(12) Patent Application Publication
(10) Pub. No.: US 2008/0047246 A1
(43) Pub. Date: Feb. 28, 2008

(54) VARIABLE SPEED TRANSMISSION TWIST-GRIP THROTTLE CONTROL APPARATUSES AND METHODS FOR SELF-PROPELLED MOWING MACHINE

(76) Inventor: Christopher M. Osborne, Hillsborough, NC (US)

Correspondence Address: JENKINS, WILSON, TAYLOR & HUNT, P. A., 3100 TOWER BLVD., Suite 1200, DURHAM, NC, 27707, US

(21) Appl. No.: 11/848,294

(22) Filed: Aug. 31, 2007

Related U.S. Application Data
(62) Division of application No. 10/751,801, filed on Jan. 5, 2004.

(51) Int. Cl. A01D 69/00

(52) U.S. Cl. 56/10.8

(57) ABSTRACT

Apparatuses and methods are provided for controlling a self-propelled machine, such as a lawn mowing machine, including a housing, an engine attached to the housing, a variable speed transmission, and a twist-grip throttle control. The variable speed transmission can propel the mowing machine, and the twist-grip throttle control can be operatively connected to the variable speed transmission for controlling the variable speed transmission Self-propelled speed of the mowing machine can therefore be controlled by operating the twist-grip throttle control. The twist-grip throttle control is designed to integrally retain an operator presence control so that only a single control needs to be used by the operator during use of the mowing machine.

### RELATED APPLICATIONS

This application is a divisional patent application which claims the benefit of the filing date of U.S. Patent Application Ser. No. 10/751,801 filed Jan. 5, 2004, the disclosure of which is incorporated herein by reference in its entirety.

### TECHNICAL FIELD

The subject matter disclosed herein relates generally to apparatuses and methods for controlling operation of self-propelled machines, and more particularly to providing a variable speed transmission twist-grip throttle control for self-propelled machines such as lawn mowing machines

### BACKGROUND ART

Self-propelled machines, such as lawn mowing machines and the like, often provide handles on which controls are mounted for engagement and/or manipulation by operators or users of such machines. In particular, a “walk behind” type, self-propelled mowing machine typically has a handle extending behind a power plant or other main operative assembly of the machine for gripping by an operator as the operator walks behind the machine during movement thereof in a forward direction. Typically, one or more controls are mounted toward the end of the handle in a convenient location for the user to manipulate while gripping the handle and operating the machine. One such control is the operator presence control or “dead man” control, which generally includes a spring-biased handle which can be grasped by the operator during normal operation of the machine to enable the motor of the machine. If the operator presence control handle is thereafter released, the machine action is rapidly terminated for reasons of safety. Another well-known control is the speed control, which for self-propelled mowing machines is generally connected to a variable speed transmission associated with the engine and controls the speed of the self-propelled traction wheels. These speed controls typically comprise a lever pivotally mounted onto the machine handle such that the speed of the self-propulsion can be controlled by moving the lever back and forth, which often requires the operator to remove one hand from the handle in order to operate the speed control. These independent systems also typically require the operator to control two or more separate functions while operating the machine. Unfortunately, recent marketing research indicates that many consumers of self-propelled machines would prefer a minimum number of control mechanisms requiring manipulation during operation of such machines in order to simplify use of the machines.

Many examples exist of conventional machines that utilize multiple separate controls during the engagement and running of the machine. U.S. Pat. No. 4,281,732 to Hoch discloses a lawn mower with a control mechanism for a propelled-drive clutch wherein the control mechanism includes a dead-man control lever which operates to hold a clutch-control lever in a clutch-engage position only when the dead-man control lever is held in a lever holding position. The lawn mower is operated in a manner that upon release of the dead-man control lever, the dead-man control lever automatically moves to a lever-release position which permits the clutch-control lever to automatically move to a clutch-disengaged position. U.S. Pat. No. 4,309,862 to Carlson discloses an operator presence control belt that holds in place a throttle control lever wherein the throttle control lever can be moved forward after the operator presence control belt is engaged. A spring loaded detent on the end of the operator presence control belt holds the throttle control lever in an engaged position until the operator presence control is released such that the throttle lever and operator presence control are interlocked.

U.S. Pat. No. 4,327,539 to Bricko et al. discloses the use of a single belt to operate both the drive system and the clutch system for outdoor power equipment. The belt is first rotated counter clockwise to cause a hook to catch on a finger of the drive lever, then as the belt is rotated in a clockwise direction the hook causes the drive lever to rotate and a pin engages a recess in the clutch lever to cause the clutch to engage. Yet another patent related to prior operator presence control and drive systems is U.S. Pat. No. 4,466,232 to Beugelsdvk et al. which discloses a compact safety control assembly for lawnmowers having a cable actuated clutch between the motor and the blade which includes a dead-man function along with a operating mechanism requiring two distinct steps for engaging the clutch and initiating rotation of the lawnmower blade.

Twist-grip throttle control systems have been used for years in the motorcycle-like vehicle and outboard marine engine fields. For example, U.S. Pat. No. 4,019,402 to Leonheart discloses a motorcycle throttle twist-grip control unit that is connected by a Bowden cable to the carburetor of the motorcycle. Likewise, U.S. Pat. No. 4,133,193 to Sanada et al. discloses a throttle grip locking device of a motorcycle having at one end of a handle a rotary throttle grip to control the operation of the engine wherein, when the engine is stopped, the throttle grip would be locked so as to be non-rotatable. U.S. Pat. No. 4,191,065 to Golobay et al. discloses a twistable type throttle grip assembly especially adapted for use with motorcycle-like vehicles wherein the throttle grip assembly manipulates a single control cable and is normally operational in a first rotational range for controlling the supply of fuel to the vehicles internal combustion engine thereby controlling the vehicle speed.

Regarding the outboard marine motor field, U.S. Pat. No. 5,545,064 to Tsunekawa et al. discloses a throttle and transmission control assembly adapted to be mounted on the tiller of an outboard motor for controlling its transmission and throttle wherein both the transmission and throttle controls employ devices that convert rotary into reciprocating motion and which amplify the reciprocating motion so as to permit a compact assembly. U.S. Pat. No. 6,093,066 to Isogawa et al. describes an outboard motor throttle and transmission control that employs a Bowden wire mechanism for transmitting control signals from the tiller handle to the engine throttle and transmission control. A twist-grip throttle control and a pivotally supported transmission control are mounted on a tiller arm and are connected by a Bowden wire actuating mechanism to the respective components of an outboard motor. Finally, U.S. patent application No. US2001/0046819 to Kawai et al. discloses an outboard motor featuring a compact throttle control and transmission shifting control on a handle connected to a tiller. The throttle control mechanism includes a twist-grip throttle control that is connected to a throttle control shaft that is journalled by a first bearing and a second bearing in a suitable manner for changing the speed of the engine.

Therefore, it would advantageous to employ a twist-grip throttle control that is operatively connected to a variable speed transmission of a self-propelled mowing machine to control the speed of propulsion. The twist-grip throttle control can be used in conjunction with an operator presence control so that a single control can be used by the operator once the engine control and speed systems are engaged.

### SUMMARY

According to one embodiment, a self-propelled mowing machine comprises a housing, an engine attached to the housing, a variable speed transmission, and a twist-grip throttle control. The variable speed transmission propels the self-propelled mowing machine, and the twist-grip throttle control is operatively connected to the variable speed transmission for controlling the variable speed transmission. Self-propelled speed of the machine can therefore be controlled by operating the twist-grip throttle control.

According to another embodiment, a mowing machine comprises a housing having front, rear, upper and lower portions and a handle attached to the rear upper portion of the housing. An engine is attached to the housing for providing power to the mowing machine. The mowing machine further comprises a variable speed transmission, a twist-grip throttle control, a machine control component, an operator presence control and a cutting element disposed within the lower portion of the housing and rotatably coupled to the engine. The variable speed transmission can propel the mowing machine, and the twist-grip throttle control is operatively connected to the variable speed transmission. The machine control component can be used to enable and disable the engine such as through the engagement and disengagement of clutches that drive the engine and/or mower blades, and can be in a variety of other configurations as known to those skilled in the art. The operator presence control is operatively connected to the machine control component for controlling the machine control component.

Methods are also provided for controlling propulsion speed of a self-propelled mowing machine. The methods generally comprise rotating a twist-grip throttle control on a self-propelled lawn mowing machine to control a variable speed transmission on the mowing machine wherein the variable speed transmission controls the propulsion speed of the mowing machine.

It is therefore an object to provide twist-grip throttle control apparatuses and methods for a self-propelled machine, such as a lawn mowing machine.

An object having been stated hereinabove, and which is achieved in whole or in part by the subject matter disclosed herein, other objects will become evident as the description proceeds when taken in connection with the accompanying drawings as best described hereinbelow.

### BRIEF DESCRIPTION OF THE DRAWINGS

FIG. 1 is a perspective view of a self-propelled mowing machine including an embodiment of a twist-grip throttle control provided in accordance with the subject matter disclosed herein;

FIG. 1B is a side elevation view of the machine illustrated in FIG. 1A;

FIG. 2A is a perspective view of the upper section of a mowing machine handle illustrating one embodiment of the twist-grip throttle control positioned in the center of the horizontal handle section;

FIG. 2B is a perspective view of the upper section of a mowing machine handle illustrating another embodiment of the twist-grip throttle control positioned on the right side of the horizontal handle section;

FIG. 2C is a perspective view of the upper section of a mowing machine handle illustrating another embodiment of the twist-grip throttle control positioned on the left side of the horizontal handle section,

FIG. 3A is a side elevation view of the upper section of a self-propelled mowing machine handle, illustrating the twist-grip throttle control and the operator presence control, both in a NEUTRAL position;

FIG. 3B is a side elevation view of the upper section of a self-propelled mowing machine handle, illustrating the twist-grip throttle control in a NEUTRAL position and the operator presence control in an ENGAGED position;

FIG. 3C is a side elevation view of the upper section of a self-propelled mowing machine handle, illustrating the twist-grip throttle control and the operator presence control, both in the ENGAGED position wherein the twist-grip throttle control is rotatably translated to a LOW speed position; and

FIG. 3D is a side elevation view of the upper section of a self-propelled machine handle, illustrating the twist-grip throttle control and the operator presence control, both in the ENGAGED position wherein the twist-grip throttle control is rotatably translated to a HIGH speed position.

### DETAILED DESCRIPTION

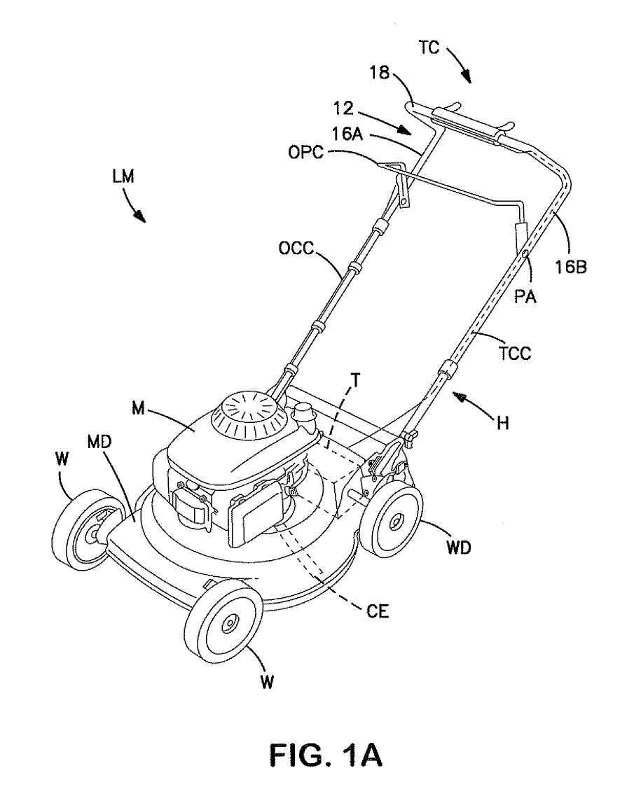

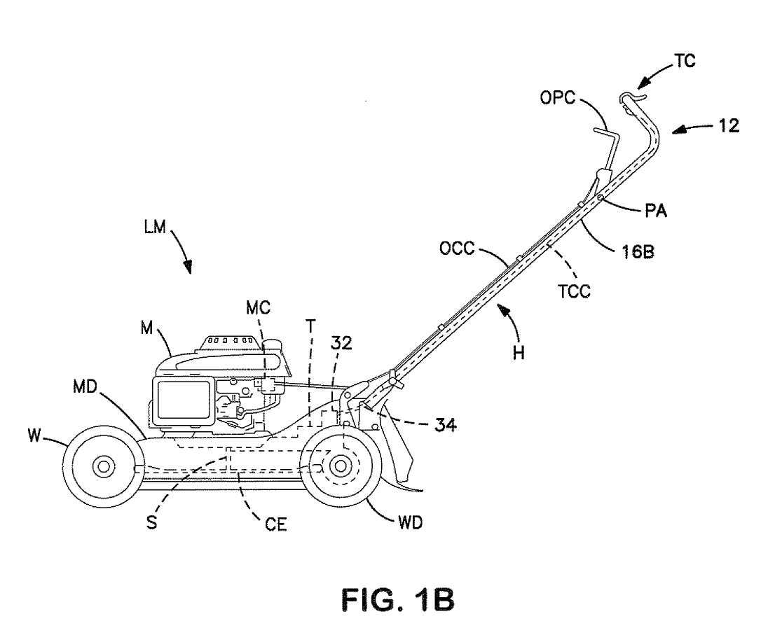

Referring now to FIGS. 1A and 1B, a self-propelled lawn mowing machine, generally designated LM, is illustrated by way of example. Lawnmower LM can comprise any suitable configuration generally known to persons skilled in the art or later developed. In the exemplary embodiment, lawnmower LM includes a housing such as a mower deck MD, which includes front, rear, upper exterior, and lower interior portions. A handle H is coupled to the rear portion of mower deck MD by any suitable means, and extends upwardly therefrom at an angle appropriate for comfortable grasping and manipulation by an operator. Handle H includes a proximal end section generally designated 12, which is the section farthest away from the main operational components of lawn mower LM such as motor M and transmission T, and which is intended to be gripped by the operator. In one embodiment, proximal end section 12 of handle H is generally U-shaped, and thus includes first and second spaced-apart legs 16A and 16B, respectively, joined by a central portion 18.

Mower deck MD is supported for rolling movement over a surface by a set of wheels and can include one or more idle (non-driving) wheels, such as wheels W, and one or more driving wheels, such as driving wheels WD. The embodiment is not limited to which one or more of wheels W functions as driving wheel or wheels WD, although typically the rearmost wheel or wheels serve this function.

Lawnmower LM can also include a powered drive system or assembly. The powered drive system can include a suitable motor M, such as an electric motor or an internal combustion engine, and transmission T, both of which can be mounted to the upper exterior portion of mower deck MD in a suitable manner. As shown in FIG. 1B, an output shaft S of motor M can rotate a suitable cutting element CE such as a blade or blades disposed within the lower interior portion of mower deck MD. Motor M also can transfer power to driving wheels WD through transmission T, thereby rendering lawnmower LM self-propelled in response to control by the operator. Torque from output shaft S can, for example, be transferred to an input shaft (not shown) of transmission T via an endless belt (not shown). Torque from the input shaft can be transferred to an additional output shaft (e.g., an axle or half-shaft coupled to respective driving wheels WD) through an appropriate reducing or transfer means such as a gear set (not shown). In advantageous embodiments, transmission T is a variable-speed transmission, and particularly a continuously variable-speed transmission. As appreciated by persons skilled in the art, by providing an appropriate control mechanism further defined herein, an operator can control the output speed of a continuously variable-speed transmission, and thus the speed of driving wheels WD, over a continuous or substantially continuous range between a zero or LOW speed and a maximum HIGH speed.

The different types, structures, and functions of the components of lawnmower LM just described are generally known to persons skilled in the art, and therefore are not further described.

As illustrated in FIGS. 1A and 1B and as appreciated by persons skilled in the art, lawnmower LM includes an operator presence control OPC which is pivotably coupled or attached to handle H at a suitable pivot axis PA which may comprise an axle, pin, bolt, dowel, or the like. Preferably, operator presence control OPC is disposed at or near proximal end section 12 of handle H (i.e., the portion of handle H proximate to the operator in the course of typical use of lawnmower LM) to facilitate manipulation by an operator. As shown in FIG. 1B, operator presence control OPC communicates with a machine control component MC that is designed for enabling and disabling an engine as appreciated by those skilled in the art. Operator presence control OPC can communicate with the machine control component MC through an operator control cable OCC. As appreciated by persons skilled in the art, operator control cable OCC can be any suitable elongate component that is either flexible or ridged and capable of transferring a force or actuation by translation and/or a change in tension. A non-limiting example of operator control cable OCC may be a cable, such as a Bowden wire, at least a portion of which is typically encased and extended through a coaxial sheath.

As appreciated by persons skilled in the art, operator presence control OPC in general is a safety feature that is typically movable between two states, ON and OFF, and typically is biased towards its OFF state. When the operator is operating or manipulating lawnmower LM in an intended matter, such as by properly gripping handle H and pulling operator presence control OPC towards handle H, operator presence control OPC is in the ON position, and this action translates through the length of operator control cable OCC to machine control component MC. The ON position permits machine control component MC to activate motor M and cutting element CE and permits lawnmower LM to be propelled using the power generated by motor M as transferred by transmission T. When, on the other hand, the operator is not operating or manipulating lawnmower LM in an intended matter, such as by releasing or failing to properly grip operator presence control OPC, the operator presence control OPC is in the OFF position. The OFF position disables machine control component MC and therein disables motor M, cutting element CE, and/or transmission T. In some embodiments and as known to those of skill in the art, a biasing mechanism (not shown) can be employed to bias operator presence control OPC to the OFF position. For example, operator control cable OCC could be biased at some point along its length to maintain a force that tends to pull operator presence control OPC away from handle H to the angled OFF position. As another example, a biasing force could be applied to machine control component MC and transferred through operator control cable OCC to yield the same result.

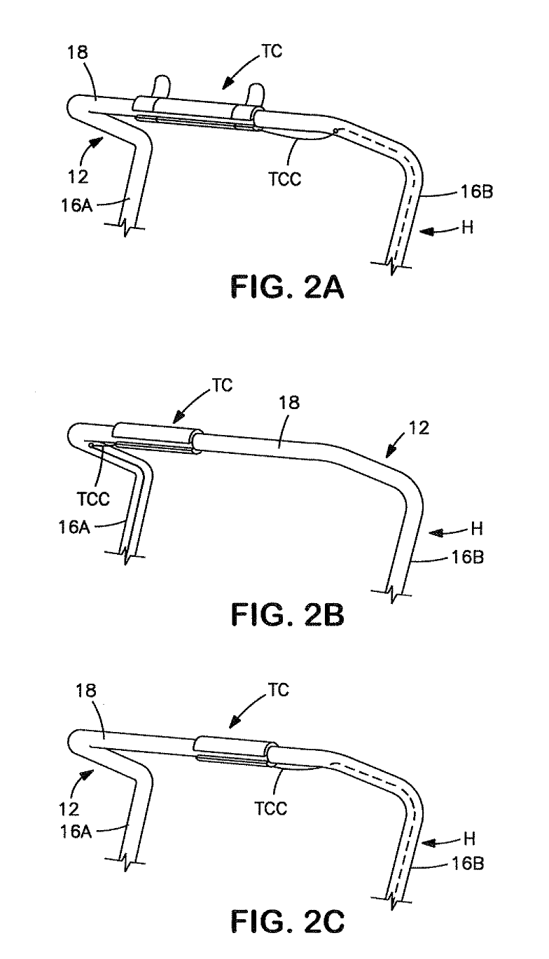

As illustrated in FIGS. 1A and 1B, lawnmower LM further includes a twist-grip throttle control generally designated TC. Twist-grip throttle control TC is rotatably coupled or attached to handle H and can be disposed at or near a proximal end section 12 of handle H. As shown in FIG. 2A, twist-grip throttle control TC can be mounted substantially coaxial in the center of central portion 18 of upper section 12 of handle H and be of any suitable and desirable width. Alternatively and as depicted in FIGS. 2B and 2C, twist-grip throttle control TC can be coupled to the right or left side of central portion 18 of upper end section 12 of handle H and be of any suitable and desirable width.

Twist-grip throttle control TC communicates with transmission T through a transmission control cable TCC, which similar to the operation control cable OCC, can be any suitable elongate component capable of transferring a force or actuation by translation and/or a change in tension (i.e., a Bowden wire). As known to those skilled in the art, transmission control cable TCC may be run from twist-grip throttle control TC to transmission T on the outside of handle H typically encased and extended through a coaxial sheath, may be run on the inside of handle H as shown in FIGS. 1A and 1B, or may be run with portions of transmission control cable TCC on both the inside and outside of handle H.

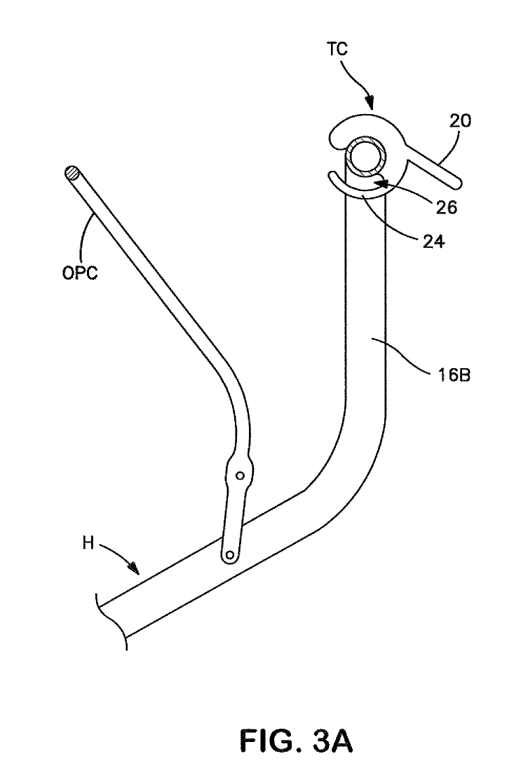

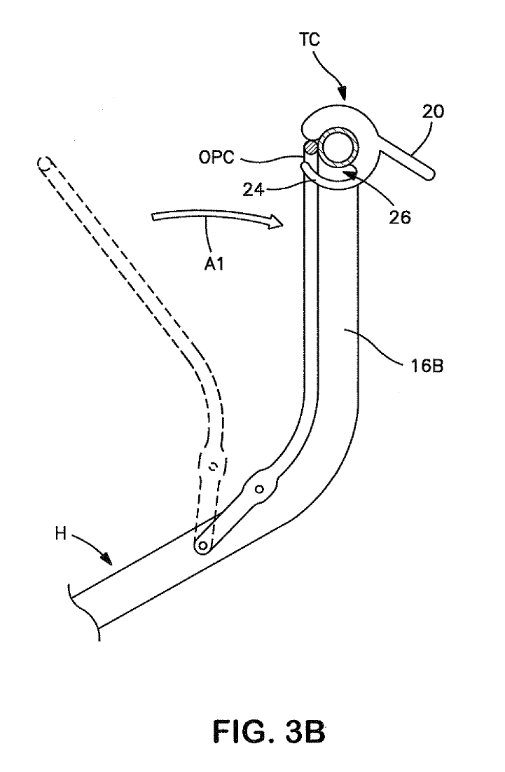

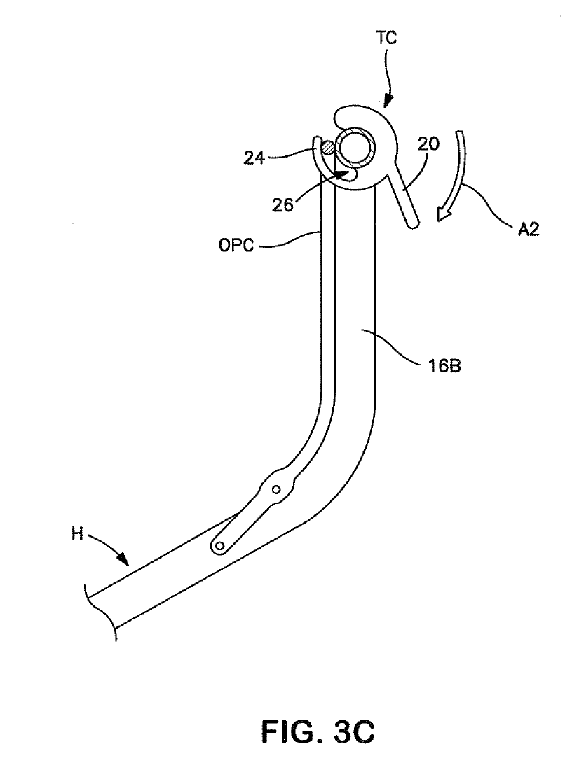

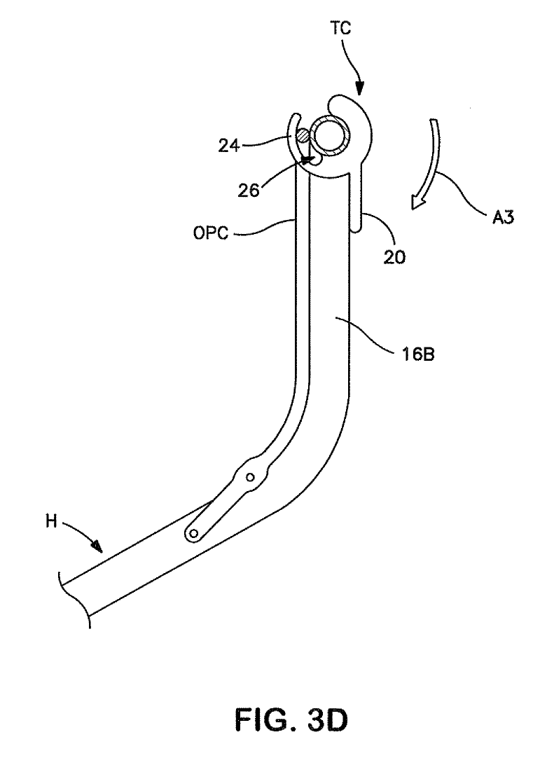

Referring now to FIGS. 3A-3D, twist-grip throttle control TC can be cylindrical in shape and can include a hook portion 24 that defines a channel 26. Hook portion 24 and channel 26 can be designed and adopted to integrally mate with operator presence control OPC the operational function of which will be described in more detail hereinbelow. Twist-grip throttle control TC can further include one or more tabs or engagement portions 20. Engagement portions 20 can be essentially elongated tabs fused preferably to opposing ends of twist-grip throttle control TC, providing a surface which the operator can push with one or more of the operator's thumbs in order to rotate the twist-grip throttle control TC through the range of operational states.

As appreciated by persons skilled in the art, actuation and the position of twist-grip throttle control TC can determine the speed at which lawnmower LM is self-propelled, and thus is movable between a NEUTRAL state at which the speed of lawnmower LM can be zero, a LOW state at which the speed of lawnmower LM can be a low speed, and a HIGH state at which the speed of lawnmower LM can be at a maximum operating speed, and often is movable to intermediate states between the LOW and HIGH states. In a preferred embodiment, twist-grip throttle control TC can rotate from approximately 90 degrees to approximately 180 degrees when rotating between a NEUTRAL state and a HIGH state.

In lawnmowers equipped with continuously variable-speed transmissions, the throttle of motor M (when provided as an internal combustion engine) is typically fixed at a constant or substantially constant setting (i.e., the speed of the motor is constant, such as 3100 rpm) during normal cuffing operations. Often, this throttle setting corresponds to an optimized motor speed at which components of motor M can rotate in a balanced manner with minimal vibration, while maintaining the effectiveness of cutting element CE. Nonetheless, as appreciated by persons skilled in the art, provision can be made for adjusting the throttle in special circumstances, such as to a choke setting for improved start-up conditions.

As shown in FIG. 1B, due to the normally constant throttle setting, twist-grip throttle control TC typically interfaces with transmission T through a transmission control component 32 to adjust one or more components thereof. Accordingly, a distal end or end section 34 of transmission control cable TCC is illustrated in FIG. 1B as being connected to transmission control component 32, which in turn is integrally attached to transmission T. Depending on the particular design of transmission T, transmission control component 32 can be mechanically associated with a cam, variable-pitch pulley, dog clutch, cone clutch, friction or pressure plate, gear, fluid control circuit, brake and/or other suitable device as appreciated by persons skilled in the art. The NEUTRAL state of twist-grip throttle control TC can correspond to a condition in which such a device decouples power transfer between motor M and transmission T.

In some embodiments and as appreciated by those skilled in the art, twist-grip throttle control TC can be biased to the NEUTRAL position by a biasing mechanism (not shown). For example, transmission control cable TCC can be biased at some point along its length to maintain a force that tends to rotate twist-grip throttle control TC into the NEUTRAL position. As another example, a biasing force could be applied to transmission control component 32 and transferred through transmission control cable TCC to yield the same result.

The operation and positioning of twist-grip throttle control TC to increase the speed of a lawnmower will now be described, with reference to FIGS. 3A-3D. FIG. 3A shows the OFF position of lawnmower LM, which is the normal position during non-use of lawnmower LM. In the OFF position as shown in FIG. 3A, operator presence control OPC and twist-grip throttle control TC can both be in an OFF or NEUTRAL position wherein motor M is disabled. Referring now to FIG. 3B, to activate motor M, such as by cranking an internal combustion engine, the operator first rotates operator presence control OPC from the OFF position shown in FIG. 3A to the ON position shown in FIG. 3B by pulling operator presence control OPC towards handle H in the direction of arrow A1. As shown in FIG. 3B, while the operator presence control OPC is now in an ON or ENGAGED position, the twist-grip throttle control TC remains in a zero speed NEUTRAL position at which no power is transferred by transmission T from motor M to driving wheels WD. Such an embodiment is useful for preventing lawnmower LM from jerking forward immediately upon startup. Depending on the type of transmission T with which twist-grip throttle control TC is interfaced, the zero speed NEUTRAL position can, if desired, involve a physical detachment in the power transmission path between motor M and driving wheel WD such as the disengagement of a clutch, or a stoppage in rotation of some critical component such as through application of a braking or friction device.

After motor M has been activated, and while continuing to hold the operator presence control OPC in the ON position to maintain powered operation of lawnmower LM, the operator can rotate twist-grip throttle control TC in the direction of arrow A2 as shown in FIG. 3C, such that twist-grip throttle control TC reaches the engaged LOW speed position shown in FIG. 3C. At this point, hook portion 24 of twist-grip throttle control TC extends over the horizontal portion of operator presence control OPC such that operator presence control OPC is now held firmly in position against handle H. With twist-grip throttle control TC in this extreme LOW speed position, power is transferred by transmission T from motor M to driving wheel WD at the lowest speed available. As shown in FIG. 3D, the operator can further rotate twist-grip throttle control TC in the direction of arrow A3 until twist-grip throttle control TC reaches the extreme HIGH speed position. While twist grip throttle control TC is in the range between the extreme LOW speed position and the extreme HIGH speed position, operator presence control OPC can be firmly held against handle H by hook portion 24 and channel 26 of twist-grip throttle control TC, allowing the operator to control lawnmower LM with one control device. The operator can adjust the speed of lawnmower LM by rotating twist-grip throttle control TC within the linear range of travel between the extreme LOW speed position and the extreme HIGH speed position. Upon completion of mowing activity or in any situation when the lawnmower must be disabled immediately, the operator can merely release twist-grip throttle control TC and twist-grip throttle control TC will rotate back from an extreme HIGH speed position to the extreme LOW speed position and further to the NEUTRAL position Once twist-grip throttle control TC passes through the extreme LOW speed position, hook portion 24 will release operator presence control OPC and operator presence control OPC will return to its NEUTRAL position, thus disabling motor M.

As can be appreciated by those skilled in the art, any conventional structure can be used for twist-grip throttle control TC. For example, U.S. Pat. No. 4,019,402 to Leonheart, U.S. Pat. No. 4,133,193 to Sanada et al., and U.S. Pat. No. 4,191,065 to Golobay et al. each disclose twist-grip throttle control units used in the motorcycle-like vehicle art area. Likewise, U.S. Pat. No. 5,545,064 to Tsunekawa et al., U.S. Pat. No. 6,093,066 to Isogawa et al., and U.S. patent application No. US2001/0046819 to Kawai et al. each disclose twist-grip throttle control units used in the outboard marine motor field. Twist-grip throttle control TC as disclosed herein can comprise any suitable structure or combination of structures from the twist-grip throttle control units of these individual patents, which are hereby incorporated by reference, or the structure of any twist-grip throttle unit known by those of skill in the art.

It will be understood that various details of the disclosed subject matter may be changed without departing from the scope of the disclosed subject matter. Furthermore, the foregoing description is for the purpose of illustration only, and not for the purpose of limitation.

What is claimed is:

1. A variable speed, self-propelled mowing machine comprising:
(a) a housing having a prime mover attached to the housing with a variable speed transmission for propelling the mowing machine;
(b) a handle attached to the housing; and
(c) a variable speed twist control comprising an elongate body moveable in a twisting manner, the body having an inner channel adapted for guiding a cable control connector operatively connected to the variable speed transmission through a cable for controlling the variable speed transmission, wherein the variable speed twist control is moveable to cause the cable control connector to move within the inner channel to control the speed of the mowing machine.

2. The self-propelled mowing machine according to claim 1 wherein the twist control is rotatable between a neutral position where the variable speed transmission is disengaged and the mowing machine is at rest, and an engaged position where the variable speed transmission is engaged and the mowing machine is self-propelled.

3. The self-propelled mowing machine according to claim 2 wherein the twist control is further rotatable in the engaged position between a low position at which the variable speed transmission is set to a minimum speed and a high position at which the variable speed transmission is set to a maximum speed.

4. The self-propelled mowing machine according to claim 3 wherein the twist control is rotatable through an arc of at least about 90 degrees.

5. The self-propelled mowing machine according to claim 4 wherein the twist control is rotatable from at least about 90 degrees to about 180 degrees.

6. The self-propelled mowing machine according to claim 1 wherein the twist control body is coaxial with the handle.

7. The self-propelled mowing machine according to claim 1 wherein the inner channel is at least generally helical.

8. The self-propelled mowing machine according to claim 1 wherein the cable control connector is a pinion mechanism connected to the cable, and the cable control connector is disposed at least partially within the inner channel whereby rotating the twist control body causes the pinion to traverse within the channel to provide movement to the cable.

9. The self-propelled mowing machine according to claim 8 wherein the twist control further comprises a guide bracket disposed between the twist control body and the handle for guiding the pinion cable control connector in a direction at least generally parallel with the portion of the handle coaxial with the twist control.

10. The self-propelled mowing machine according to claim 1 further comprising:
(a) a machine control component for enabling and disabling the prime mover; and
(b) an operator presence control operatively connected to the machine control component for controlling the machine control component whereby enabling and disabling of the prime mover can be controlled by operating the operator presence control.

11. The self-propelled mowing machine according to claim 10 wherein the operator presence control is translatable between a neutral or off position and an engaged or on position.

12. The self-propelled mowing machine according to claim 11 wherein the engaged position enables the machine control component and wherein the neutral position disables the machine control component.

13. A method of controlling propulsion of a self-propelled mowing machine comprising:
(a) providing a variable speed, self-propelled mowing machine comprising:
(i) a housing having a prime mover attached to the housing with a variable speed transmission for propelling the mowing machine;
(ii) a handle attached to the housing; and
(iii) a variable speed twist control comprising an elongate body moveable in a twisting manner, the body having an inner channel adapted for guiding a cable control connector operatively connected to the variable speed transmission through a cable; and
(b) rotating the twist control to cause the cable control connector to move within the inner channel to control the variable speed transmission whereby the variable speed transmission controls the propulsion speed of the self-propelled mowing machine.

14. The method according to claim 13 wherein rotating the twist control increases and decreases the propulsion speed of the self-propelled mowing machine.

15. A variable speed, self-propelled mowing machine comprising:
(a) a housing having a prime mover attached to the housing with a variable speed transmission for propelling the mowing machine;
(b) a handle attached to the housing; and
(c) a variable speed twist control disposed coaxial to the handle and comprising an elongate body moveable in a twisting manner about the handle, the body having an inner channel adapted for guiding a cable control connector operatively connected to the variable speed transmission through a cable for controlling the variable speed transmission, whereby self-propelled speed of the mowing machine can be controlled by operating the twist control.

16. The self-propelled mowing machine according to claim 15 wherein the twist control is rotatable between a neutral position where the variable speed transmission is disengaged and the mowing machine is at rest, and an engaged position where the variable speed transmission is engaged and the mowing machine is self-propelled.

17. The self-propelled mowing machine according to claim 16 wherein the twist control is further rotatable in the engaged position between a low position at which the variable speed transmission is set to a minimum speed and a high position at which the variable speed transmission is set to a maximum speed.

18. The self-propelled mowing machine according to claim 17 wherein the twist control is rotatable through an arc of at least about 90 degrees.

19. The self-propelled mowing machine according to claim 18 wherein the twist control is rotatable from at least about 90 degrees to about 180 degrees.

20. The self-propelled mowing machine according to claim 15 wherein the inner channel is at least generally helical.

21. The self-propelled mowing machine according to claim 15 wherein the cable control connector is a pinion mechanism connected to the cable, and the cable control connector is disposed at least partially within the inner channel whereby rotating the twist control body causes the pinion to traverse within the channel to provide movement to the cable.

22. The self-propelled mowing machine according to claim 21 wherein the twist control further comprises a guide bracket disposed between the twist control body and the handle for guiding the pinion cable control connector in a direction at least generally parallel with the portion of the handle coaxial with the twist control.
